(19) United States
(12) Patent Application Publication
(10) Pub. No.: US 2024/0214540 A1
(43) Pub. Date: Jun. 27, 2024

(54) METHOD FOR TRANSMITTING PANORAMIC VIDEOS, TERMINAL AND SERVER

(71) Applicant: ZTE CORPORATION, Shenzhen (CN)

(72) Inventor: Cheng HUANG, Shenzhen (CN)

(21) Appl. No.: 18/600,494

(22) Filed: Mar. 8, 2024

Related U.S. Application Data
(63) Continuation of application No. 16/469,355, filed on Jun. 13, 2019.

(30) Foreign Application Priority Data
Dec. 13, 2016 (CN) 201611149103.X

(51) Int. Cl. H04N 13/194; H04N 13/111; H04N 13/161; H04N 13/264

(52) U.S. Cl. CPC H04N 13/194; H04N 13/111; H04N 13/161; H04N 13/264

(57) ABSTRACT

Disclosed are a method and device for transmitting a panoramic video. The method includes: requesting a server for acquiring a first panoramic video file; and upon detecting a change in a viewing angle of a user, according to an FOV type of the first panoramic video file, requesting the server for acquiring a second panoramic video file or an auxiliary FOV video file of the first panoramic video file.

### CROSS-REFERENCES TO RELATED APPLICATIONS

This is a continuation application of U.S. application Ser. No. 16/469,355, which was a National Stage Application, filed under 35 U.S.C. 371, of International Patent Application No. PCT/CN2017/115943, filed on Dec. 13, 2017, which further claims priority to Chinese patent application No. 201611149103.X filed on Dec. 13, 2016, contents of all of which are incorporated herein by reference in their entireties.

### TECHNICAL FIELD

The present disclosure relates to video transmission technologies and, in particular, to a method and device for transmitting a panoramic video, a terminal, a server, and a system.

### BACKGROUND

Virtual Reality (VR) means to simulate and create a three-dimensional virtual world by use of computer technologies and enable users to experience a highly vivid virtual space from senses of sight, hearing, touch, and taste. With the rapid development of the VR technology, there are more and more VR (panoramic) video live broadcasts, videos on demand services, and other applications, which provides users with a very immersive video traffic experience.

Online transmission of VR panoramic videos are mainly performed in two technical manners: a full-view transmission scheme and a field of view (FOV) transmission scheme. In the full-view transmission scheme, the 360-degree surround pictures are transmitted to the terminal and all the processing procedures are implemented locally by the terminal to switch the pictures when the user turns his head. A VR panoramic video, in the same monocular visual resolution, has a much larger code rate than an ordinary plane video due to a frame rate, a bit depth, 360 degrees, and the like. The code rate of the VR panoramic video is generally 5 to 10 times that of the ordinary plane video. Taking a VR extreme panoramic video with a monocular resolution of 8K as an example, the required bandwidth reaches 5G bandwidth, which is a great challenge for the network and results in increased costs. Although, the panoramic video is of 360-degree, a viewer can only see the current field of view of the whole 360-degree panoramic video when viewing. The part which is not seen by the user occupies the network bandwidth, but is not utilized actually, wasting much network resources. In terms of this case, the industry has proposed a transmission scheme for differentiated transmission of the VR video based on the viewing angle, that is, the FOV transmission scheme. In the FOV transmission scheme, the visible picture in the current viewing angle is mainly transmitted. Generally, the 360-degree panoramic view is divided into several viewing angles, and a video file is generated for each viewing angle. The video transmitted to the terminal only includes high-resolution visual information in the user's viewing angle and low-resolution visual information in the peripheral part. The terminal requests, according to the current viewing angle pose and position of the user, the server for the video file corresponding to the viewing angle. When the head of the user rotates and the viewing angle of the user changes, the terminal requests a video file corresponding to the new viewing angle from the server. In the FOV-based transmission scheme, there are a total of 30 viewing angles. The size of the video file for each viewing angle is only 20% of the original file, and the transmission code rate is only 20% of the original code rate, which greatly reduces bandwidth requirements for viewing the VR video and improves the effective bandwidth utilization rate. This scheme also has the disadvantage that a total size of the video files for all the viewing angles is 6 times the size of the original file, which will occupy more storage space of the server. This scheme which reduces the delay with increased storage sacrifices partial image quality experience.

### SUMMARY

To solve the preceding problem, embodiments of the present disclosure provide a method and device for transmitting a panoramic video, a terminal, a server, and a system.

An embodiment of the present disclosure provides a method for transmitting a panoramic video. The method includes:
requesting a server for acquiring a first panoramic video file.
upon detecting a change in a viewing angle of a user, according to an FOV type of the first panoramic video file, requesting the server for acquiring a second panoramic video file or an auxiliary FOV video file of the first panoramic video file.

In an embodiments of the present disclosure, the FOV type of the first panoramic video file includes at least one of the following types:
the first panoramic video file has no predetermined FOV;
the first panoramic video file has a predetermined auxiliary FOV;
the first panoramic video file has a predetermined primary FOV; or
the first panoramic video file has the predetermined primary FOV and the predetermined auxiliary FOV.

In an embodiments of the present disclosure, according to the FOV type of the first panoramic video file, requesting the server for acquiring the second panoramic video file or the auxiliary FOV video file of the first panoramic video file includes:
if the first panoramic video file has the predetermined auxiliary FOV, and a variance of the viewing angle of the user is greater than a first threshold, requesting the server for acquiring the auxiliary FOV video file of the first panoramic video file.

In an embodiments of the present disclosure, according to the FOV type of the first panoramic video file, requesting the server for acquiring the second panoramic video file or the auxiliary FOV video file of the first panoramic video file includes:
if the first panoramic video file has the predetermined primary FOV, and a variance of the viewing angle of the user is greater than a second threshold, requesting the server for acquiring the second panoramic video file.

In an embodiments of the present disclosure, according to the FOV type of the first panoramic video file, requesting the server for acquiring the second panoramic video file or the auxiliary FOV video file of the first panoramic video file includes:
if the first panoramic video file has the predetermined primary FOV and the predetermined auxiliary FOV, and a variance of the viewing angle of the user is less than a second threshold and greater than or equal to a third threshold, requesting the server for acquiring the auxiliary FOV video file of the first panoramic video file; otherwise, requesting the server for acquiring the second panoramic video file.

In an embodiments of the present disclosure, the method further includes:
requesting the server for acquiring a media presentation description, where the media presentation description includes a correspondence between the viewing angle of the user and a video file which includes a panoramic video file and an auxiliary FOV video file.

In an embodiments of the present disclosure, the media presentation description further includes a correspondence between the panoramic video file and the auxiliary FOV video file.

In an embodiments of the present disclosure, requesting the server for acquiring the auxiliary FOV video file of the first panoramic video file includes:
when a variance of the viewing angle of the user is greater than a first threshold, determining that a current viewing angle of the user is a first viewing angle; and
according to the correspondence between the viewing angle of the user and the video file, requesting the server for acquiring the auxiliary FOV video file of the first panoramic video file corresponding to the first viewing angle.

In an embodiments of the present disclosure, requesting the server for acquiring the second panoramic video file includes:
when a variance of the viewing angle of the user is greater than or equal to a second threshold, determining that a current viewing angle of the user is a second viewing angle; and
according to the correspondence between the viewing angle of the user and the video file, requesting the server for acquiring the second panoramic video file corresponding to the second viewing angle.

In an embodiments of the present disclosure, requesting the server for acquiring the auxiliary FOV video file of the first panoramic video file includes:
when a variance of the viewing angle of the user is less than a second threshold and greater than or equal to a third threshold, determining that a current viewing angle of the user is a third viewing angle; and
according to the correspondence between the viewing angle of the user and the video file, requesting the server for acquiring the auxiliary FOV video file of the first panoramic video file corresponding to the third viewing angle.

In an embodiments of the present disclosure, the method further includes:
when requesting the server for acquiring the second panoramic video file or the auxiliary FOV video file of the first panoramic video file, carrying in the request a playback starting time point of the second panoramic video file or the auxiliary FOV video file of the first panoramic video file.

Another embodiment of the present disclosure provides a method for transmitting a panoramic video. The method includes:
sending a media presentation description of a panoramic video file to a terminal, where the media presentation description includes an FOV type of the panoramic video file.

In an embodiments of the present disclosure, the FOV type of the panoramic video file includes at least one of the following types:
the panoramic video file has no predetermined FOV;
the first panoramic video file has a predetermined auxiliary FOV;
the panoramic video file has a predetermined primary FOV; or
the panoramic video file has the predetermined primary FOV and the predetermined auxiliary FOV.

In an embodiments of the present disclosure, the media presentation description further includes a correspondence between the panoramic video file and its auxiliary FOV video file.

An embodiment of the present disclosure provides a device for transmitting a panoramic video. The device includes a first acquisition unit and a second acquisition unit.

The first acquisition unit is configured to request a server for acquiring a first panoramic video file.

The second acquisition unit is configured to: upon detecting a change in a viewing angle of a user, according to an FOV type of the first panoramic video file, request the server for acquiring a second panoramic video file or an auxiliary FOV video file of the first panoramic video file.

In an embodiments of the present disclosure, the FOV type of the first panoramic video file includes at least one of the following types:
the first panoramic video file has no predetermined FOV;
the first panoramic video file has a predetermined auxiliary FOV;
the first panoramic video file has a predetermined primary FOV; or
the first panoramic video file has the predetermined primary FOV and the auxiliary FOV.

In an embodiments of the present disclosure, the second acquisition unit is specifically configured to: if the first panoramic video file has the predetermined auxiliary FOV and a variance of the viewing angle of the user is greater than a first threshold, request the server for acquiring the auxiliary FOV video file of the first panoramic video file.

In an embodiments of the present disclosure, the second acquisition unit is specifically configured to: if the first panoramic video file has the predetermined primary FOV and a variance of the viewing angle of the user is greater than a second threshold, request the server for acquiring the second panoramic video file.

In an embodiments of the present disclosure, the second acquisition unit is specifically configured to: if the first panoramic video file has the predetermined primary FOV and the auxiliary FOV, and a variance of the viewing angle of the user is less than a second threshold and greater than or equal to a third threshold, request the server for acquiring the auxiliary FOV video file of the first panoramic video file; otherwise request the server for acquiring the second panoramic video file.

In an embodiments of the present disclosure, the device further includes a third acquisition unit.

The third acquisition unit is configured to request the server for acquiring a media presentation description, where the media presentation description includes a correspondence between the viewing angle of the user and a video file which includes a panoramic video file and an auxiliary FOV video file.

In an embodiments of the present disclosure, the media presentation description further includes a correspondence between the panoramic video file and its auxiliary FOV video file.

In an embodiments of the present disclosure, the second acquisition unit is specifically configured to: when a variance of the viewing angle of the user is greater than a first threshold, determine that a current viewing angle of the user is a first viewing angle; and according to the correspondence between the viewing angle of the user and the video file, request the server for acquiring the auxiliary FOV video file of the first panoramic video file corresponding to the first viewing angle.

In an embodiments of the present disclosure, the second acquisition unit is specifically configured to: when a variance of the viewing angle of the user is greater than or equal to a second threshold, determine that a current viewing angle of the user is a second viewing angle; and according to the correspondence between the viewing angle of the user and the video file, request the server for acquiring the second panoramic video file corresponding to the second viewing angle.

In an embodiments of the present disclosure, the second acquisition unit is specifically configured to: when a variance of the viewing angle of the user is less than a second threshold and greater than or equal to a third threshold, determine that a current viewing angle of the user is a third viewing angle; and according to the correspondence between the viewing angle of the user and the video file, request the server for acquiring the auxiliary FOV video file of the first panoramic video file corresponding to the third viewing angle.

In an embodiments of the present disclosure, when requesting the server for acquiring the second panoramic video file or the auxiliary FOV video file of the first panoramic video file, a playback starting time point of the second panoramic video file or the auxiliary FOV video file of the first panoramic video file is carried in the request.

Another embodiment of the present disclosure provides a device for transmitting a panoramic video. The device includes a sending unit.

The sending unit is configured to send a media presentation description of a panoramic video file to a terminal, where the media presentation description includes an FOV type of the panoramic video file.

In an embodiments of the present disclosure, the FOV type of the panoramic video file includes at least one of the following types:
the panoramic video file has no predetermined FOV;
the first panoramic video file has a predetermined auxiliary FOV;
the panoramic video file has a predetermined primary FOV; or
the panoramic video file has the predetermined primary FOV and auxiliary FOV.

In an embodiments of the present disclosure, the media presentation description further includes a correspondence between the panoramic video file and an auxiliary FOV video file.

An embodiment of the present disclosure provides a terminal. The terminal includes a processor and a memory storing instructions executable by the processor. When the instructions are executed by the processor, the processor is configured to:
request a server for acquiring a first panoramic video file; and
upon detecting a change in a viewing angle of a user, according to an FOV type of the first panoramic video file, request the server for acquiring a second panoramic video file or an auxiliary FOV video file of the first panoramic video file.

In an embodiments of the present disclosure, the FOV type of the first panoramic video file includes at least one of the following types:
the first panoramic video file has no predetermined FOV;
the first panoramic video file has a predetermined auxiliary FOV;
the first panoramic video file has a predetermined primary FOV; or
the first panoramic video file has the predetermined primary FOV and the auxiliary FOV.

An embodiment of the present disclosure provides a server. The server includes a processor and a memory storing instructions executable by the processor. When the instructions are executed by the processor, the processor is configured to:
send a media presentation description of a panoramic video file to a terminal, where the media presentation description includes an FOV type of the panoramic video file.

In an embodiments of the present disclosure, the FOV type of the panoramic video file includes at least one of the following types:
the panoramic video file has no predetermined FOV;
the first panoramic video file has a predetermined auxiliary FOV;
the panoramic video file has a predetermined primary FOV; or
the panoramic video file has the predetermined primary FOV and auxiliary FOV.

An embodiment of the present disclosure provides a system for transmitting a panoramic video. The system includes a terminal and a server.

The terminal includes a first processor and a first memory storing instructions executable by the first processor. When the instructions are executed by the first processor, the first processor is configured to: request the server for acquiring a first panoramic video file; and upon detecting a change in a viewing angle of a user, according to an FOV type of the first panoramic video file, request the server for acquiring a second panoramic video file or an auxiliary FOV video file of the first panoramic video file.

The server includes a second processor and a second memory storing instructions executable by the second processor. When the instructions are executed by the second processor, the second processor is configured to send a media presentation description of a panoramic video file to the terminal, where the media presentation description includes the FOV type of the panoramic video file.

In the embodiments of the present disclosure, the FOV type of the panoramic video file includes at least one of the following types:
the panoramic video file has no predetermined FOV;
the first panoramic video file has a predetermined auxiliary FOV;
the panoramic video file has a predetermined primary FOV; or
the panoramic video file has the predetermined primary FOV and auxiliary FOV.

In the technical solutions provided by the embodiments of the present disclosure, the terminal requests the server for acquiring the first panoramic video file; and upon detecting a change in the viewing angle of the user, the terminal requests, according to the FOV type of the first panoramic video file, the server for acquiring the second panoramic video file or the auxiliary FOV video file of the first panoramic video file. With the technical solutions in the embodiments of the present disclosure, when the viewing angle of the user for viewing the panoramic video is changed, visual experience of an image quality in a switching process is guaranteed, thereby providing better video experience for the user as much as possible under a limited bandwidth.

### BRIEF DESCRIPTION OF DRAWINGS

The drawings described herein are used to provide a further understanding of the present disclosure and form a part of the present application. The exemplary embodiments and descriptions thereof in the present disclosure are used to explain the present disclosure and not to limit the present disclosure in any improper way. In the drawings:

FIG. 1 is a flowchart 1 of a method for transmitting a panoramic video according to an embodiment of the present disclosure;

FIG. 2 is a flowchart 2 of a method for transmitting a panoramic video according to an embodiment of the present disclosure;

FIG. 3 is a flowchart 3 of a method for transmitting a panoramic video according to an embodiment of the present disclosure;

FIG. 4 is a flowchart 4 of a method for transmitting a panoramic video according to an embodiment of the present disclosure;

FIG. 5 is a flowchart 5 of a method for transmitting a panoramic video according to an embodiment of the present disclosure;

FIG. 6 is a flowchart of a method for transmitting a panoramic video according to an embodiment 1 of the present disclosure;

FIG. 7 is a schematic diagram illustrating an application of the embodiment 1 of the present disclosure;

FIG. 8 is a flowchart of a method for transmitting a panoramic video according to an embodiment 2 of the present disclosure;

FIG. 9 is a schematic diagram illustrating an application of the embodiment 2 of the present disclosure;

FIG. 10 is a structural diagram 1 of a device for transmitting a panoramic video according to an embodiment of the present disclosure;

FIG. 11 is a structural diagram 2 of a device for transmitting a panoramic video according to an embodiment of the present disclosure; and

FIG. 12 is a structural diagram of a system for transmitting a panoramic video according to an embodiment of the present disclosure.

### DETAILED DESCRIPTION

To provide a more detailed understanding of features and content of embodiments of the present disclosure, implementation of the embodiments of the present disclosure is described below in detail with reference to the drawings. The drawings are provided for reference only and are not intended to limit the embodiments of the present disclosure.

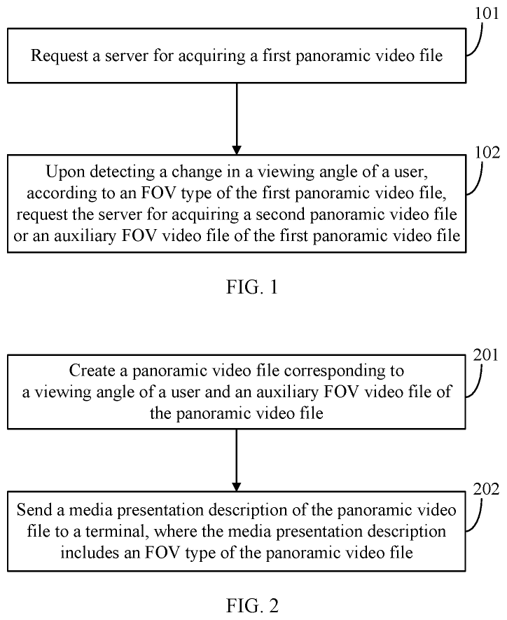

FIG. 1 is a flowchart 1 of a method for transmitting a panoramic video according to an embodiment of the present disclosure. As shown in FIG. 1, the method for transmitting a panoramic video includes steps described below.

In step 101, a request is made to a server for acquiring a first panoramic video file.

Before request the server for acquiring the first panoramic video file, the method further includes: request the server for acquiring a media presentation description.

In the embodiments of the present disclosure, the media presentation description further includes FOV type information of the panoramic video file, as shown in the following table:

TABLE 1

| Applicable | | |
|---|---|---|
| set or | | |
| Representation | Use | Description |
| FOV_type | Optional | non-negative integer: identifying a |
| | | predetermined FOV type of a 360- |
| | | degree video: |
| | | 0: indicating absence of a predetermined |
| | | FOV; |
| | | 1: indicating presence of a predetermined |
| | | auxiliary FOV; |
| | | 2: indicating presence of a predetermined |
| | | primary FOV; |
| | | 3: indicating presence of the predetermined |
| | | primary FOV and the auxiliary FOV; |
| | | other values. |

In the embodiments of the present disclosure, the media presentation description includes a correspondence between a viewing angle of a user and a video file. The video file includes the panoramic video file and the auxiliary FOV video file.

A correspondence between the viewing angle of the user and the panoramic video file is established based on the predetermined primary FOV of the panoramic video file. Description information for the predetermined primary FOV of the panoramic video file in the media presentation description is shown in the following table:

TABLE 2

| Basic Attribute | | |
|---|---|---|
| Value or Supplemental | | |
| Attribute Value | Use | Description |
| Primary_yaw | Mandatory | Azimuthal angle of a primary |
| | | viewing direction |
| Primary_pitch | Mandatory | Pitch angle of the primary viewing |
| | | direction |
| Primary_FOV_width | Optional | Horizontal field angle of the |
| | | primary FOV |
| Primary_FOV_height | Optional | Vertical field angle of the primary |
| | | FOV |

A correspondence between the viewing angle of the user and the auxiliary FOV video file is established based on spatial region information of the auxiliary FOV video file. The spatial region information of the auxiliary FOV video file in the media presentation description is shown in the following table:

TABLE 3

| Basic Attribute | | |
|---|---|---|
| Value or Supplemental | | |
| Attribute Value | Use | Description |
| geometry_type | Mandatory | non-negative integer: defining a |
| | | geometry type of the spatial region: |
| | | 0: conventional Euclidean coordinate |
| | | system |
| | | 1: spherical geometric coordinate |
| | | system |
| | | 2: two-dimensional planar projection |
| | | index |
| | | other values. |
| region_yaw_left | Mandatory | Minimum azimuthal angle of the |
| | | spatial region |
| region_yaw_right | Mandatory | Maximum azimuthal angle of the |
| | | spatial region |
| region_pitch_top | Mandatory | Maximum pitch angle of the spatial |
| | | region |
| region_pitch_bot | Mandatory | Minimum pitch angle of the spatial |
| | | region |

The media presentation description further includes a correspondence between the panoramic video file and its auxiliary FOV video file, as shown in the following table:

TABLE 4

| Supplemental | | |
|---|---|---|
| Attribute | | |
| Value Parameter | Use | Description |
| fov_source_id | Optional | a list of non-negative integers for |
| | | providing identifiers of the auxiliary FOV |
| | | video files of the panoramic video file |

In step 102, when it is detected that the viewing angle of the user changes, according to the FOV type of the first panoramic video file, a request is made to the server for acquiring a second panoramic video file or an auxiliary FOV video file of the first panoramic video file.

Here, the FOV type of the first panoramic video file includes at least one of the types described below.

The first panoramic video file has no predetermined FOV.

The first panoramic video file has the predetermined auxiliary FOV.

The first panoramic video file has the predetermined primary FOV.

The first panoramic video file has the predetermined primary FOV and auxiliary FOV.

Accordingly, if the first panoramic video file has the predetermined auxiliary FOV and a variance of the viewing angle of the user is greater than a first threshold, the request made to the server is for acquiring the auxiliary FOV video file of the first panoramic video file.

Accordingly, if the first panoramic video file has the predetermined primary FOV and the variance of the viewing angle of the user is greater than a second threshold, the request made to the server is for acquiring the second panoramic video file.

Accordingly, if the first panoramic video file has the predetermined primary FOV and the auxiliary FOV, and the variance of the viewing angle of the user is less than the second threshold and greater than or equal to a third threshold, the request made to the server is for acquiring the auxiliary FOV video file of the first panoramic video file, otherwise the request made to the server is for acquiring the second panoramic video file.

In the case where the first panoramic video file has the predetermined auxiliary FOV, when the variance of the viewing angle of the user is greater than the first threshold, it is determined that a current viewing angle of the user is a first viewing angle; and according to the correspondence between the viewing angle of the user and the video file, the request is made to the server for acquiring the auxiliary FOV video file of the first panoramic video file corresponding to the first viewing angle.

When the variance of the viewing angle of the user is greater than or equal to the second threshold, it is determined that the current viewing angle of the user is a second viewing angle; and according to the correspondence between the viewing angle of the user and the video file, the request is made to the server for acquiring the second panoramic video file corresponding to the second viewing angle.

In the case where the first panoramic video file has the predetermined primary FOV and the auxiliary FOV, when the variance of the viewing angle of the user is less than the second threshold and greater than or equal to the third threshold, it is determined that the current viewing angle of the user is a third viewing angle; and according to the correspondence between the viewing angle of the user and the video file, the request is made to the server for acquiring the auxiliary FOV video file of the first panoramic video file corresponding to the third viewing angle.

When making the request to the server for acquiring the second panoramic video file or the auxiliary FOV video file of the first panoramic video file, a playback starting time point of the second panoramic video file or the auxiliary FOV video file of the first panoramic video file is carried in the request.

The preceding method for transmitting a panoramic video based on the FOV type supports requirements of multiple 360-degree video transmission scenarios which include the following:

TABLE 5

| Video | Encoding | | |
|---|---|---|---|
| Content | Mode | FOV Type | Transmission Scheme |
| Panoramic | Single | — | Single stream transmission |
| video | resolution | Auxiliary FOV | Multi-stream transmission |
| | Multiple | Primary FOV | Single stream transmission |
| | resolutions | Primary FOV | Multi-stream transmission |
| | (Non-uniform | and | |
| | qualities) | auxiliary FOV | |
| Regional | Single | Auxiliary FOV | Multi-stream transmission |
| video | resolution | | |

FIG. 2 is a flowchart 2 of a method for transmitting a panoramic video according to an embodiment of the present disclosure. As shown in FIG. 2, the method for transmitting a panoramic video includes steps described below.

In step 201, a panoramic video file corresponding to a viewing angle of a user and the auxiliary FOV video file are created.

In step 202, a media presentation description of the panoramic video file is sent to a terminal, where the media presentation description includes an FOV type of the panoramic video file.

Here, the FOV type of the panoramic video file includes at least one of the types described below.

The panoramic video file has no predetermined FOV.

The first panoramic video file has a predetermined auxiliary FOV.

The panoramic video file has a predetermined primary FOV.

The panoramic video file has the predetermined primary FOV and auxiliary FOV.

Furthermore, the media presentation description further includes a correspondence between the panoramic video file and the auxiliary FOV video file.

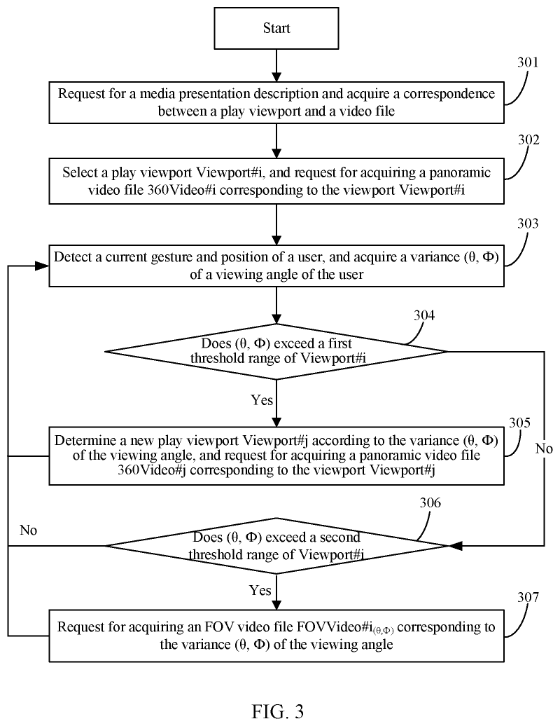

FIG. 3 is a flowchart 3 of a method for transmitting a panoramic video according to an embodiment of the present disclosure. As shown in FIG. 3, the method for transmitting a panoramic video includes steps described below.

In step 301, a terminal requests a media presentation description from a server and acquires a correspondence between a playback view angle and a video file.

In step 302, the terminal selects a playback view angle Viewport #i, and requests the server for acquiring a panoramic video file 360Video #i corresponding to the viewport Viewport #i.

In step 303, the terminal detects a current gesture and position of a user, and acquires a user view angle variance (θ, Φ).

In step 304, the terminal determines whether (θ, Φ) exceeds a first threshold range of Viewport #i. If the (θ, Φ) exceeds the first threshold range, the method proceeds to step 305. If the (θ, Φ) does not exceed the first threshold range, the method proceeds to step 306.

In step 305, the terminal determines a new playback view angle Viewport #j according to the view angle variance (θ, Φ), and makes a request to the server for acquiring a panoramic video file 360Video #j corresponding to the view angle Viewport #j. The method proceeds to step 303.

In step 306, the terminal determines whether (θ, Φ) exceeds a second threshold range of Viewport #i. If (θ, Φ) exceeds the second threshold range, the method proceeds to step 307; if (θ, Φ) does not exceed the second threshold range, the method proceeds to step 303.

In step 307, the terminal makes a request to the server for acquiring an FOV video file FOVVideo #i_{(θ, Φ)} corresponding to the viewing angle variance (θ, Φ).

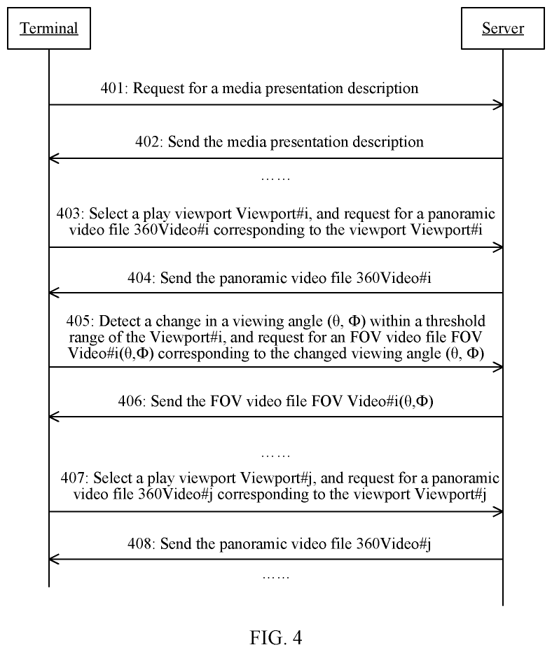

FIG. 4 is a flowchart 4 of a method for transmitting a panoramic video according to an embodiment of the present disclosure. As shown in FIG. 4, the method for transmitting a panoramic video includes steps described below.

In step 401, a terminal requests a media presentation description from a server.

In step 402, the server sends the media presentation description to the terminal.

In step 403, the terminal selects a playback view angle Viewport #i, and makes a request to the server for acquiring a panoramic video file 360Video #i corresponding to the playpack view angle Viewport #i.

In step 404, the server sends the panoramic video file 360Video #i.

In step 405, the terminal detects that the change in the viewing angle (θ, Φ) is within a threshold range of Viewport #i, and the terminal makes a request to the server for acquiring an FOV video file FOV Video #i (θ, Φ) corresponding to the changed viewing angle (θ, Φ).

In step 406, the server sends the FOV video file FOVVideo #i_{(θ, Φ)}.

In step 407, it is detected that the terminal changing viewing angle (θ, Φ) is beyond the threshold range of Viewport #i, and the terminal selects a playback view angle Viewport #j and requests a panoramic video file 360Video #j corresponding to the playback view angle Viewport #j from the server.

In step 408, the server sends the panoramic video file 360Video #j.

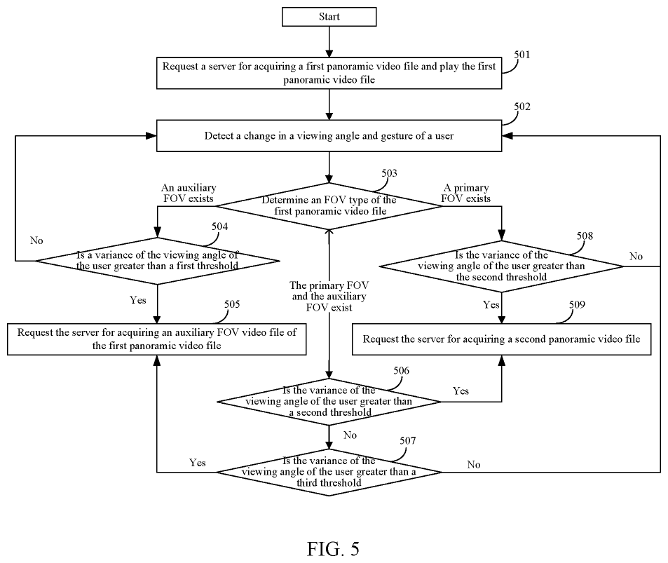

FIG. 5 is a flowchart 5 of a method for transmitting a panoramic video according to an embodiment of the present disclosure. As shown in FIG. 5, the method for transmitting a panoramic video includes steps described below.

In step 501, a terminal makes a request to a server for acquiring a first panoramic video file and plays the first panoramic video file.

In step 502, the terminal detects that a viewing angle and a gesture of a user change.

In step 503, the terminal determines an FOV type of the first panoramic video file. If the first panoramic video file has an auxiliary FOV, the method proceeds to step 504; if the first panoramic video file has a primary FOV and the auxiliary FOV, the method proceeds to step 506; and if the first panoramic video file has the primary FOV, the method proceeds to step 508.

In step 504, the terminal determines whether a variance of the viewing angle of the user is greater than a first threshold. If the variance of the viewing angle of the user is greater than the first threshold, the method proceeds to step 505; and if the variance of the viewing angle of the user is not greater than the first threshold, the, method proceeds to step 502.

In step 505, the terminal makes a request to the server for acquiring an auxiliary FOV video file of the first panoramic video file.

In step 506, the terminal determines whether the variance of the viewing angle of the user is greater than a second threshold. If the variance of the viewing angle of the user is not greater than the second threshold, the method proceeds to step 507. If the variance of the viewing angle of the user is greater than a second threshold, the method proceeds to step 509.

In step 507, the terminal determines whether the variance of the viewing angle of the user is greater than a third threshold. If the variance of the viewing angle of the user is greater than the third threshold, the method proceeds to step 505. If the variance of the viewing angle of the user is not greater than a second threshold, the method proceeds to step 502.

In step 508, the terminal determines whether the variance of the viewing angle of the user is greater than the second threshold. If the variance of the viewing angle of the user is greater than the second threshold, the method proceeds to step 509. If the variance of the viewing angle of the user is not greater than the second threshold, the method proceeds to step 502.

In step 509, the terminal makes a request to the server for acquiring a second panoramic video file.

Solutions in the embodiments of the present disclosure are further described below in conjunction with specific application scenarios.

### Embodiment 1: 360 Video on Demand Service (Unicast)

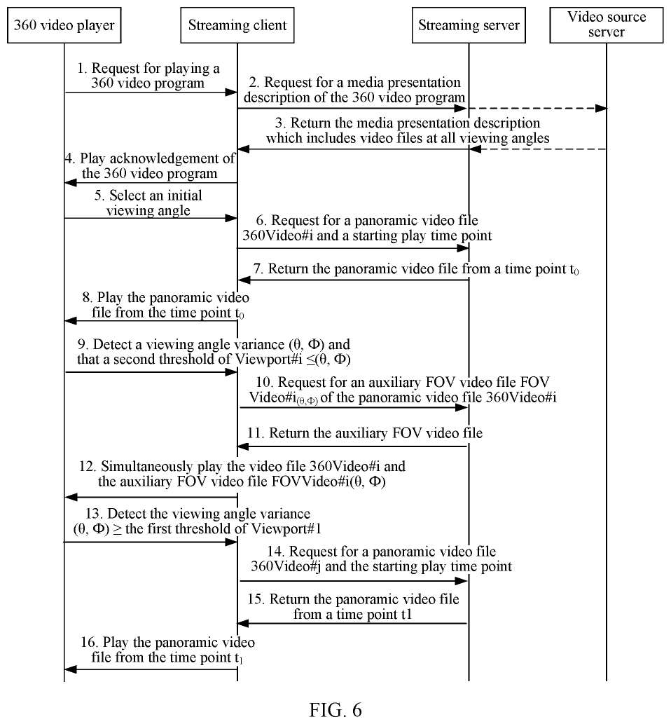

FIG. 6 is a flowchart of a method for transmitting a panoramic video according to an embodiment 1 of the present disclosure. This embodiment describes a 360 video FOV on-demand transmission. Without loss of generality, functional entities involved in this embodiment are described below.

A 360 video player, such as a virtual reality head-mounted display (HDM), can track changes in a viewing angle and a gesture of a user and magnify an image on a micro display screen through a visual optical system in front of the user's eyes so as to provide an immersive display effect of the 360 panoramic video.

A streaming client, such as a Dynamic Adaptive Streaming over HTTP (DASH) client, and provides accessing, decoding, and buffering for media resources including the 360 panoramic video and the like.

A streaming server may be any appropriate type of network server, such as a node of a content delivery network (CDN), a proxy server, a web server, or a combination thereof. The streaming client may establish a network connection with the streaming server through any access network.

A video source server implements capturing, encoding and compression, and segmentation of a video source, and divides original video content into multiple video segments with a fixed time interval. It also provides storage for a media presentation description (MPD) in the DASH.

In step 1, the 360 video player selects and requests for playing a 360 video program according to an user's instruction.

In step 2, the streaming client requests the media presentation description corresponding to the selected 360 video program from the streaming server. In practice, the streaming client may send the above request to the streaming server according to a predetermined parameter configuration (such as an access page network link). Optionally, the streaming server forwards the request to the video source server, and acquires the media presentation description corresponding to the 360 video program.

In step 3, the streaming server sends the media presentation description corresponding to the selected 360 video program. Since the 360 video FOV transmission involves video files for different viewing angles, the media presentation description sent by the server includes uniform resource locators (URLs) of video files of the 360 video program for all the viewing angles and angle relationship information.

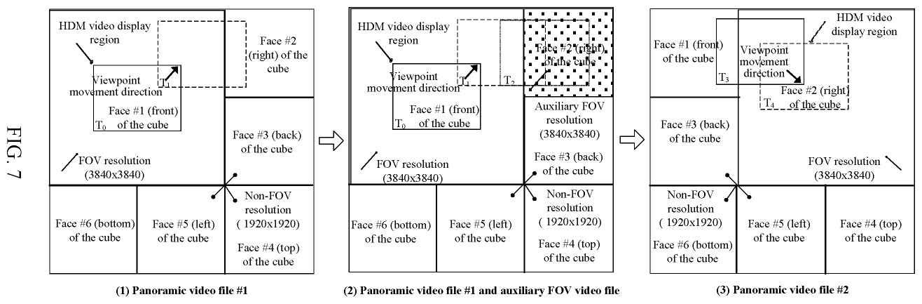

The video files related to the 360 video program in this embodiment are described below with reference to FIG. 7.

In this embodiment, the video source server pre-defines the viewing angle, gesture and position, in a spatial spherical coordinate system, of the user when the user watches the 360 video program and numbers the viewing angles from 1 to N, each of which corresponds to one viewing angle range. The video source server generates N panoramic video files 360Video #i (i=1, . . . , N) according to the numbers of the viewing angle, gesture and position of the user. As shown in FIG. 7, the video source server generates six panoramic video files 360VideoCubeFace #i (i=1, . . . , 6) in a non-uniform mapping manner based on regular hexahedral projection. Each panoramic video file has description information for a predetermined primary FOV, which includes a viewing direction of the primary FOV (a azimuthal angle and a pitch angle) and a field angle of the primary FOV (a horizontal field angle and a vertical field angle).

As shown in FIG. 7-(1), the predetermined primary FOV of the panoramic video file 360VideoCubeFace #1 is a face #1 (a front face) of projection planes of a cube. Assuming that a horizontal viewing angle is (0, 360) and a vertical viewing angle is (−90, 90) in a global spherical coordinate system, the viewing direction of the predetermined primary FOV of the panoramic video file 360VideoCubeFace #1 is (120, 30), and the field angle of the primary FOV is (240, 120).

Meanwhile, the video source server generates several auxiliary FOV video files FOVVideo #i(θ, Φ) (i=1, . . . , N) for each panoramic video file 360Video #i, and stores them in the streaming server. As shown in FIG. 7, for each panoramic video file 360VideoCubeFace #i (i=1, . . . , 6), the video source server generates 8 auxiliary FOV video files FOVVideoCubeFace #i(θ, Φ) (each primary FOV is adjacent to four projection planes of the cube, two viewing angle variation ranges (θ, Φ) and corresponding auxiliary FOVs are configured for each adjacent plane). Each auxiliary FOV video file has predetermined spatial region description information including a minimum azimuthal angle, a maximum azimuthal angle, a minimum pitch angle, and a maximum pitch angle).

As shown in FIG. 7-(2), for the primary FOV and the viewing angle variation range (θ, Φ) of an adjacent face #2 of the panoramic video file 360VideoCubeFace #1, an auxiliary FOV video file FOVVideoCubeFace #1(θ, Φ) is provided. Assuming that the horizontal viewing angle is (0, 360) and the vertical viewing angle is (−90, 90) in the global spherical coordinate system, a predetermined spatial region of the auxiliary FOV video file FOVVideoCubeFace #1(θ, Φ) is (240, 360, 30, 90).

Meanwhile, the video source server generates the corresponding media presentation description. The media presentation description carries viewing angle description information of the panoramic video file and the auxiliary FOV video files, and a correspondence between the panoramic video file and the auxiliary FOV video files.

In step 4, the streaming client returns a playback acknowledgement for the 360 video program.

In step 5, based on a configuration of the 360 video program or user selection, the 360 video player selects an initial viewing angle.

In steps 6 to 8, the streaming client requests the corresponding panoramic video file 360Video #i and a playback starting time point t0 at which the 360 video starts to be played according to the current viewing angle of the user. As shown in FIG. 7-(1), the streaming client in this embodiment requests to download the panoramic video file 360VideoCubeFace #1 according to the current viewing angle of the user and information on the primary FOV of the panoramic video file. After receiving the request, the streaming server starts to transmit panoramic video file 360VideoCubeFace #1 by addressing the time point to of the panoramic video file 360VideoCubeFace #1. After receiving minimum buffered data amount, the 360 video player starts playing the panoramic video file 360VideoCubeFace #1 from the time point to.

In steps 9 to 12, at a certain moment, the user changes the viewing angle and the gesture. For each detected viewing angle variance (θ, Φ), the streaming client determines whether the viewing angle variance (θ, Φ) exceeds a first threshold range of Viewport #i corresponding to the primary FOV of the panoramic video file 360 Video #i.

If the viewing angle variance (θ, Φ) exceeds the first threshold range, a new viewing angle, pose or position j is identified. The streaming client requests a corresponding panoramic video file 360Video #j and a playback starting time point t1 of the 360 video. After receiving the minimum buffer data amount with which the video playing can be supported, the 360 video player plays the panoramic video file 360Video #j from the time point t1 after the remaining panoramic video file 360Video #i is played.

If the viewing angle variance (θ, Φ) does not exceed the first threshold range, it is determined whether the viewing angle variance (θ, Φ) exceeds a second threshold range of Viewport #i corresponding to the primary FOV of the panoramic video file 360Video #i. If the viewing angle variance (θ, Φ) exceeds the second threshold range, the streaming client makes a request to acquire the auxiliary FOV video file FOVVideo #i(θ, Φ) corresponding to the viewing angle variance (θ, Φ). The 360 video player starts simultaneously playing the panoramic video file 360Video #i and the auxiliary FOV video file FOVVideo #i(θ, Φ) after receiving the minimum buffer data amount with which the video playing can be supported.

As shown in FIG. 7-(2), in this embodiment, when it is detected that the variance of the viewing angle is (θ, Φ), and a second threshold of Viewport #1≤(θ, Φ)<a first threshold of Viewport #1, the streaming client requests to download the auxiliary FOV video file FOVVideoCubeFace #1(θ, Φ) of the adjacent face #2 of the cube according to the variance (θ, Φ) of the viewing angle and spatial region information of the auxiliary FOV video file FOVVideoCubeFace #1(θ, Φ). After receiving the minimum buffer data amount, the 360 video player starts simultaneously playing the panoramic video file 360VideoCubeFace #1 and the auxiliary FOV video file FOVVideoCubeFace #1(θ, Φ).

In steps 13 to 16, as shown in FIG. 7-(3), it is detected at a certain moment that the viewing angle variance (θ, Φ)≥the first threshold of Viewport #1, the streaming client requests to download a panoramic video file 360VideoCubeFace #2 according to the variance (θ, Φ) of the viewing angle and information on the primary FOV of the panoramic video file. After receiving the request, the streaming server starts to transmit panoramic video file 360VideoCubeFace #2 by addressing the time point t1 of the panoramic video file 360VideoCubeFace #2. After receiving the minimum buffer data amount, the 360 video player starts playing the panoramic video file 360VideoCubeFace #2 from the time point t1.

### Embodiment 2: 360 Video Live Broadcast (Multicast)

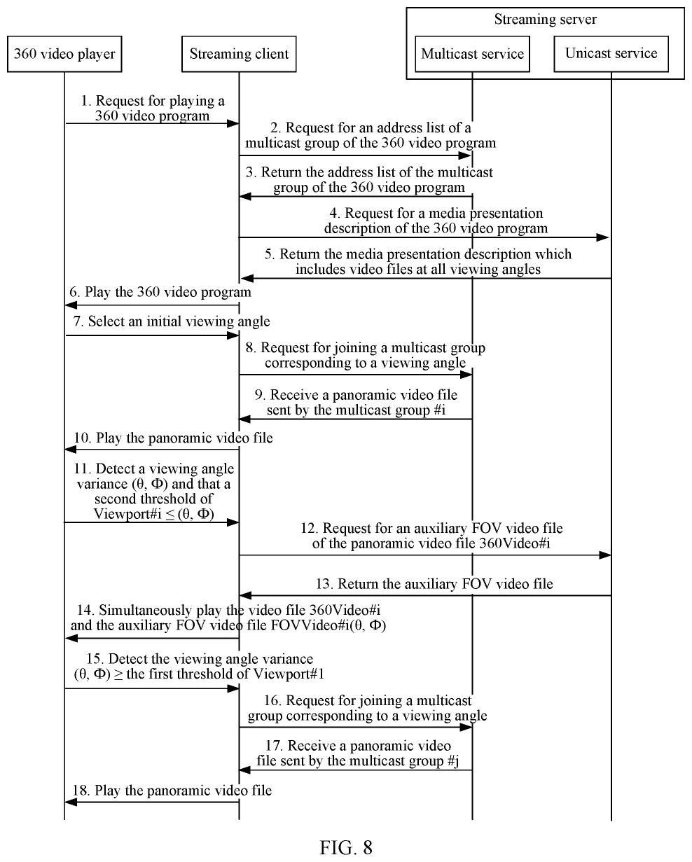

FIG. 8 is a flowchart of a method for transmitting a panoramic video according to an embodiment 2 of the present disclosure. This embodiment describes a 360 video FOV live broadcast transmission.

In step 1, the 360 video player selects a 360 video program according to the user's instruction and makes a request for playing the 360 video program.

In steps 2 and 3, for a 360 video live broadcast in a multicast transmission manner, each program includes video streams of panoramic video files at multiple viewing angles, and each viewing angle corresponds to one multicast group address. The streaming client requests the streaming server to return a multicast group list and viewing angle relationship information corresponding to the selected 360 video program.

In steps 4 and 5, to transmit an auxiliary FOV video file in a unicast manner, the streaming client request the streaming server to return a media presentation description corresponding to the selected 360 video program. Since the 360 video FOV transmission involves video files at different viewing angles, the media presentation description returned by the server includes URLs of video files of the 360 video program at all the viewing angles and information on a relationship between the video files and the viewing angles.

The video files related to the 360 video program in this embodiment are described below with reference to FIG. 9.

In this embodiment, the video source server pre-defines the viewing angle, gesture and position, in a spatial spherical coordinate system, of the user when the user watches the 360 video program and numbers the viewing angles from 1 to N, each of which corresponds to one viewing angle range. The video source server generates N panoramic video files 360Video #i(i=1 . . . N) according to the numbers of the viewing angle, gesture and position of the user. As shown in FIG. 9, the video source server generates six panoramic video files 360VideoERPTile #i (i=1, . . . , 6) in a non-uniform encoding manner based on rectangular projection. Each panoramic video file has description information for a predetermined primary FOV, which includes a viewing direction of the primary FOV (an azimuthal angle and a pitch angle) and a field angle of the primary FOV (a horizontal field angle and a vertical field angle).

As shown in FIG. 9-(1), a predetermined primary FOV of the panoramic video file 360VideoERPTile #1 is a tile #1 of projection planes of a rectangle. Assuming that a horizontal viewing angle is (0, 360) and a vertical viewing angle is (−90, 90) in a global spherical coordinate system, the viewing direction of the predetermined primary FOV of the panoramic video file 360VideoERPTile #1 is (60, 45), and the field angle of the primary FOV is (120, 80).

Meanwhile, the video source server generates several auxiliary FOV video files FOVVideo #i(θ, Φ) (i=1, . . . , N) for each panoramic video file 360Video #i, and stores them in the streaming server. As shown in FIG. 9, for each panoramic video file 360VideoERPTile #i (i=1, . . . , 6), the video source server generates 4 auxiliary FOV video files FOVVideoERPTile #i(θ, Φ) (each primary FOV is adjacent to at most four tiles among the projection planes of the rectangle, and each of tile is configured with one viewing angle variation range (θ, Φ) and corresponding auxiliary FOV). Each auxiliary FOV video file has predetermined spatial region description information including a minimum azimuthal angle, a maximum azimuthal angle, a minimum pitch angle, and a maximum pitch angle).

As shown in FIG. 9-(2), for the primary FOV and the viewing angle variation range (θ, Φ) of an adjacent tile #2 of the panoramic video file 360VideoERPTile #1, an auxiliary FOV video file FOVVideoERPTile #1(θ, Φ) is provided. Assuming that the horizontal viewing angle is (0, 360) and the vertical viewing angle is (−90, 90) in the global spherical coordinate system, a predetermined spatial region of the auxiliary FOV video file FOVVideoERPTile #1(θ, Φ) is (120, 220, 15, 90).

Meanwhile, the video source server generates the corresponding media presentation description. The media presentation description carries viewing angle description information of the panoramic video file and the auxiliary FOV video files, and a correspondence between the panoramic video file and the auxiliary FOV video files.

In step 6, the streaming client returns a playback acknowledgement for the 360 video program.

In step 7, based on a configuration of the 360 video program or user selection, the 360 video player selects an initial viewing angle.

In steps 8 to 10, according to the multicast group list and the viewing angle relationship information, the streaming client makes a request for joining a multicast group to receive the panoramic video file 360Video #i corresponding to the current viewing angle of the user. As shown in FIG. 9-(1), in this embodiment, the streaming client makes the requests for joining a multicast group #1 to receive the panoramic video file 360VideoERPTile #1. After receiving minimum buffer data amount, the 360 video player starts playing the panoramic video file 360VideoERPTile #1.

In steps 11 to 14, at a certain moment, the user changes the viewing angle and the gesture. For each detected variance (θ, Φ) of the viewing angle, the streaming client determines whether the variance (θ, Φ) of the viewing angle exceeds a first threshold range of Viewport #i corresponding to the primary FOV of the panoramic video file 360Video #i.

If the viewing angle variance (θ, Φ) exceeds the first threshold range, a new viewing angle, gesture or position j is identified. According to the multicast group list and the viewing angle relationship information, the streaming client makes a request for joining a multicast group #j to receive the corresponding panoramic video file 360Video #j. After receiving the minimum buffer data amount with which the playing can be supported, the 360 video player starts playing the panoramic video file 360Video #j.

If the viewing angle variance (θ, Φ) does not exceed the first threshold range, it is determined whether the viewing angle variance (θ, Φ) exceeds a second threshold range of Viewport #i corresponding to the primary FOV of the panoramic video file 360Video #i. If the viewing angle variance (θ, Φ) exceeds the second threshold range, the streaming client makes a request for acquiring the auxiliary FOV video file FOVVideo #i(θ, Φ) corresponding to the viewing angle variance (θ, Φ) in the unicast manner. The 360 video player starts simultaneously playing the panoramic video file 360Video #i and the auxiliary FOV video file FOVVideo #i(θ, Φ) after receiving the minimum buffer data amount which can support playback.

As shown in FIG. 9-(2), in this embodiment, when it is detected that the viewing angle variance is (θ, Φ), and a second threshold of Viewport #1≤(θ, Φ)<a first threshold of Viewport #1, the streaming client requests the auxiliary FOV video file FOVVideoERPTile #1(θ, Φ) of the adjacent tile #2 among the projection planes of the rectangle according to the viewing angle variance (θ, Φ) and spatial region information of the auxiliary FOV video file FOVVideoERPTile #1(θ, Φ). After receiving the minimum buffer data amount, the 360 video player starts simultaneously playing the panoramic video file 360VideoERPTile #1 and the auxiliary FOV video file FOVVideoERPTile #1(θ, Φ).

In steps 15 to 18, as shown in FIG. 9-(3), it is detected at a certain moment that the viewing angle variance (θ, Φ)≥the first threshold of Viewport #1, the streaming client makes the request for joining the multicast group #j to receive a panoramic video file 360VideoERPTile #2 according to the multicast group list and the viewing angle relationship information. After receiving the minimum buffer data amount, the 360 video player starts playing the panoramic video file 360VideoCubeFace #2.

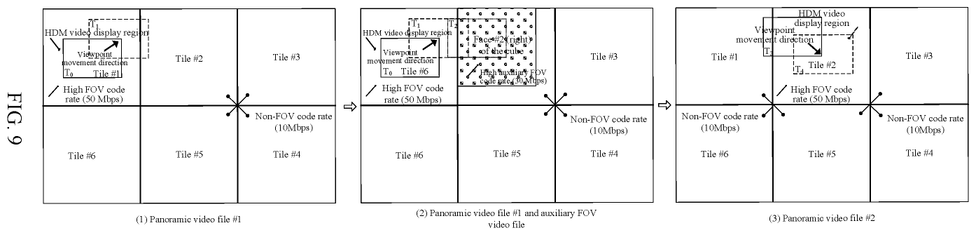

FIG. 10 is a structural diagram 1 of a device for transmitting a panoramic video according to an embodiment of the present disclosure. As shown in FIG. 10, the device includes a first acquisition unit 1001 and a second acquisition unit 1002.

The first acquisition unit 1001 is configured to make a request to a server for acquiring a first panoramic video file.

The second acquisition unit 1002 is configured to: when it is detected that a viewing angle of a user changes, according to an FOV type of the first panoramic video file, make a request to the server for acquiring a second panoramic video file or an auxiliary FOV video file of the first panoramic video file.

In the embodiments of the present disclosure, the FOV type of the first panoramic video file includes at least one of the types described below.

The first panoramic video file has no predetermined FOV.

The first panoramic video file has a predetermined auxiliary FOV.

The first panoramic video file has a predetermined primary FOV.

The first panoramic video file has the predetermined primary FOV and the auxiliary FOV.

In the embodiments of the present disclosure, the second acquisition unit 1002 is specifically configured to: if the first panoramic video file has the predetermined auxiliary FOV and a variance of the viewing angle of the user is greater than a first threshold, request the server for acquiring the auxiliary FOV video file of the first panoramic video file.

In the embodiments of the present disclosure, the second acquisition unit 1002 is specifically configured to: if the first panoramic video file has the predetermined primary FOV and the variance of the viewing angle of the user is greater than a second threshold, request the server for acquiring the second panoramic video file.

In the embodiments of the present disclosure, the second acquisition unit 1002 is specifically configured to: if the first panoramic video file has the predetermined primary FOV and the auxiliary FOV, and the variance of the viewing angle of the user is less than the second threshold and greater than or equal to a third threshold, request the server for acquiring the auxiliary FOV video file of the first panoramic video file; otherwise request the server for acquiring the second panoramic video file.

In the embodiments of the present disclosure, the device further includes a third acquisition unit 1003.

The third acquisition unit 1003 is configured to request the server for acquiring a media presentation description. The media presentation description includes a correspondence between the viewing angle of the user and a video file. The video file includes a panoramic video file and an auxiliary FOV video file.

In the embodiments of the present disclosure, the media presentation description further includes a correspondence between the panoramic video file and the auxiliary FOV video file.

In the embodiments of the present disclosure, in the case where the first panoramic video file has the predetermined auxiliary FOV, the second acquisition unit 1002 is specifically configured to: when the variance of the viewing angle of the user is greater than the first threshold, determine that a current viewing angle of the user is a first viewing angle; and according to the correspondence between the viewing angle of the user and the video file, request the server for acquiring the auxiliary FOV video file of the first panoramic video file corresponding to the first viewing angle.

In the embodiments of the present disclosure, the second acquisition unit 1002 is specifically configured to: when the variance of the viewing angle of the user is greater than or equal to the second threshold, determine that the current viewing angle of the user is a second viewing angle; and according to the correspondence between the viewing angle of the user and the video file, request the server for acquiring the second panoramic video file corresponding to the second viewing angle.

In the embodiments of the present disclosure, in the case where the first panoramic video file has the predetermined primary FOV and the auxiliary FOV, the second acquisition unit 1002 is specifically configured to: when the variance of the viewing angle of the user is less than the second threshold and greater than or equal to the third threshold, determine that the current viewing angle of the user is a third viewing angle; and according to the correspondence between the viewing angle of the user and the video file, request the server for acquiring the auxiliary FOV video file of the first panoramic video file corresponding to the third viewing angle.

In the embodiments of the present disclosure, when the request is made to the server for acquiring the second panoramic video file or the auxiliary FOV video file of the first panoramic video file, a playback starting time point of the second panoramic video file or the auxiliary FOV video file of the first panoramic video file is carried in the request.

It should be understood by those skilled in the art that implementation of functions of various units of the device for transmitting a panoramic video in FIG. 10 may be understood with reference to the related description of the method for transmitting a panoramic video described above. The functions of the various units of the device for transmitting a panoramic video in FIG. 10 may be implemented by programs running on a processor or by specific logic circuits.

Based on the device for transmitting a panoramic video in FIG. 10, the embodiments of the present disclosure further provide a terminal. The terminal includes a processor and a memory storing instructions executable by the processor. When the instructions are executed by the processor, the processor is configured to perform steps described below.

A request is made to a server to acquire a first panoramic video file.

When it is detected that a viewing angle of a user changes, a request is made, according to an FOV type of the first panoramic video file, to the server to acquire a second panoramic video file or an auxiliary FOV video file of the first panoramic video file.

It should be understood by those skilled in the art that the processor in the terminal can also execute all the functions of the device for transmitting a panoramic video in FIG. 10.

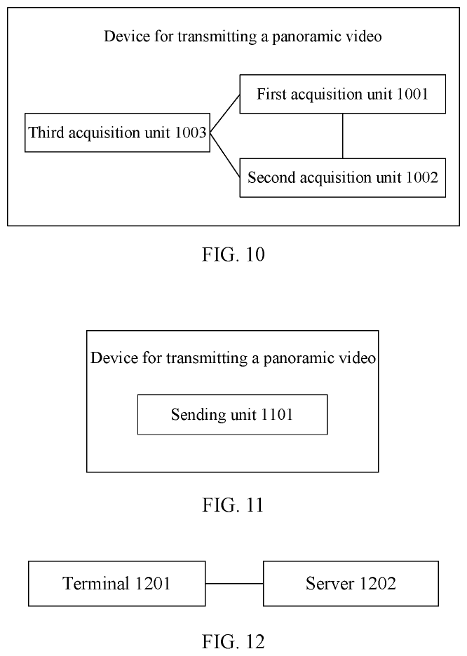

FIG. 11 is a structural diagram 2 of a device for transmitting a panoramic video according to an embodiment of the present disclosure. As shown in FIG. 11, the device includes a sending unit 1001.

The sending unit 1101 is configured to send a media presentation description of a panoramic video file to a terminal. The media presentation description includes an FOV type of the panoramic video file.

In the embodiments of the present disclosure, the FOV type of the panoramic video file includes at least one of the types described below.

The panoramic video file has no predetermined FOV.

The first panoramic video file has a predetermined auxiliary FOV.

The panoramic video file has a predetermined primary FOV.

The panoramic video file has the predetermined primary FOV and the auxiliary FOV.

In the embodiments of the present disclosure, the media presentation description further includes a correspondence between the panoramic video file and an auxiliary FOV video file.

It should be understood by those skilled in the art that implementation of functions of various units of the device for transmitting a panoramic video shown in FIG. 11 may be understood with reference to the related description of the method for transmitting a panoramic video described above. The functions of the various units of the device for transmitting a panoramic video in FIG. 11 may be implemented by programs running on a processor or by specific logic circuits.

Based on the device for transmitting a panoramic video in FIG. 11, the embodiments of the present disclosure further provide a server. The server includes a processor and a memory storing instructions executable by the processor. When the instructions are executed by the processor, the processor is configured to perform a step described below.

A media presentation description of a panoramic video file is sent to a terminal. The media presentation description includes an FOV type of the panoramic video file.

It should be understood by those skilled in the art that the processor in the server can also execute all the functions of the device for transmitting a panoramic video in FIG. 11.

FIG. 12 is a structural diagram of a system for transmitting a panoramic video according to an embodiment of the present disclosure. As shown in FIG. 12, the system includes a terminal 1201 and a server 1202.

The terminal 1201 includes a first processor and a first memory storing instructions executable by the first processor. When the instructions are executed by the first processor, the first processor is configured to perform the method steps in FIG. 1.

The server 1202 includes a second processor and a second memory storing instructions executable by the second processor. When the instructions are executed by the second processor, the second processor is configured to perform the method steps in FIG. 2.

It should be understood by those skilled in the art that the embodiments of the present disclosure may be provided as methods, systems, or computer program products. Therefore, the present disclosure may adopt a form of a hardware embodiment, a software embodiment, or a combination of hardware and software embodiments. In addition, the present disclosure may adopt a form of a computer program product implemented on one or more computer-usable storage media (including, but not limited to, a disk memory, an optical memory and the like) which include computer-usable program codes.

The present disclosure is described with reference to flowcharts and/or block diagrams of methods, apparatus (systems) and computer program products according to the embodiments of the present disclosure. It should be understood that computer program instructions may implement each flow and/or block in the flowcharts and/or block diagrams and a combination of flows and/or blocks in the flowcharts and/or block diagrams. These computer program instructions may be provided to a general-purpose computer, a special-purpose computer, an embedded processor or a processor of another programmable data processing apparatus to produce a machine so that instructions executed by a computer or the processor of another programmable data processing apparatus produce a means for implementing functions specified in one or more flows in the flowcharts and/or one or more blocks in the block diagrams.

These computer program instructions may also be stored in a computer-readable memory which may direct the computer or another programmable data processing apparatus to operate in a particular manner so that the instructions stored in the computer-readable memory produce a manufactured product including an instructing means. The instructing means implements the functions specified in one or more flows in the flowcharts and/or one or more blocks in the block diagrams.

These computer program instructions may also be loaded onto the computer or another programmable data processing apparatus so that a series of operation steps are performed on the computer or another programmable apparatus to produce processing implemented by the computer. Therefore, instructions executed on the computer or another programmable apparatus provide steps for implementing the functions specified in one or more flows in the flowcharts and/or one or more blocks in the block diagrams.

The above are only preferred embodiments of the present disclosure and are not intended to limit the scope of the present disclosure.

What is claimed is:

1. A method for a user terminal device requesting a panoramic video, comprising:
requesting a server for acquiring a media presentation description which comprises field of view, FOV, type information;
requesting the server for acquiring a first panoramic video file based on the media presentation description; and
upon detecting a change in a viewing angle of the user, the method being characterized in:
determining a FOV type of the first panoramic video file, wherein the FOV type of the first panoramic video file comprises at least one of the following:
the first panoramic video file has no predetermined FOV
the first panoramic video file has a predetermined auxiliary FOV;
the first panoramic video file has a predetermined primary FOV; or
the first panoramic video file has the predetermined primary FOV and the auxiliary FOV;
wherein, if the first panoramic video file has an auxiliary FOV, or a primary FOV, or a primary FOV and an auxiliary FOV, requesting the server, according to the FOV type of the first panoramic video file and the change of the viewing angle of the user, a second panoramic video file or an auxiliary FOV video file of the first panoramic video file;
wherein requesting, according the FOV type of the first panoramic video file and the change of the viewing angle of the user, the server for acquiring the second panoramic video file) or the auxiliary FOV video file of the first panoramic video file comprises:
requesting in a single stream, in a case where the first panoramic video file has the predetermined primary FOV; and
requesting in multiple streams, in a case where the first panoramic video file has the predetermined auxiliary FOV;
wherein the single stream is a single virtual reality media stream corresponding to a user's current viewpoint in the primary FOV; and
the multiple streams comprise a panoramic video without the primary FOV, and a plurality of virtual reality media streams of virtual reality block videos with the auxiliary FOV corresponding to a user's current viewpoint or the multiple streams comprise a plurality of virtual reality media streams corresponding to a user's current viewpoint in virtual reality block videos.

2. The method for transmitting a panoramic video of claim 1, wherein the FOV type of the first panoramic video file comprises at least one of the following:
the first panoramic video file has no predetermined FOV;
the first panoramic video file has a predetermined auxiliary FOV;
the first panoramic video file has a predetermined primary FOV; or
the first panoramic video file has the predetermined primary FOV and the auxiliary FOV.

3. The method for transmitting a panoramic video of claim 2, wherein the requesting, according to the FOV type of the first panoramic video file, the server for the second panoramic video file or the auxiliary FOV video file of the first panoramic video file comprises:
if the first panoramic video file has the predetermined auxiliary FOV, and a variance of the viewing angle of the user is greater than a first threshold, requesting the server for the auxiliary FOV video file of the first panoramic video file.

4. The method for transmitting a panoramic video of claim 2, wherein the requesting, according to the FOV type of the first panoramic video file, the server for the second panoramic video file or the auxiliary FOV video file of the first panoramic video file comprises:
if the first panoramic video file has the predetermined primary FOV, and a variance of the viewing angle of the user is greater than a second threshold, requesting the server for the second panoramic video file.

5. The method for transmitting a panoramic video of claim 2, wherein the requesting, according to the FOV type of the first panoramic video file, the server for the second panoramic video file or the auxiliary FOV video file of the first panoramic video file comprises:
if the first panoramic video file has the predetermined primary FOV and the auxiliary FOV, and a variance of the viewing angle of the user is less than a second threshold and greater than or equal to a third threshold, requesting the server for the auxiliary FOV video file of the first panoramic video file; if the variance of the viewing angle of the user is greater than the second threshold, requesting the server for the second panoramic video file.

6. The method for transmitting a panoramic video of claim 1, further comprising:
requesting the server for a media presentation description, wherein the media presentation description comprises a correspondence between the viewing angle of the user and a video file, wherein the video file comprises a panoramic video file and an auxiliary FOV video file.

7. The method for transmitting a panoramic video of claim 6, wherein the media presentation description further comprises a correspondence between the panoramic video file and the auxiliary FOV video file.

8. The method for transmitting a panoramic video of claim 6, wherein requesting the server for the auxiliary FOV video file of the first panoramic video file comprises:
when a variance of the viewing angle of the user is greater than a first threshold, determining that a current viewing angle of the user is a first viewing angle; and
according to the correspondence between the viewing angle of the user and the video file, requesting the server for the auxiliary FOV video file of the first panoramic video file corresponding to the first viewing angle.

9. The method for transmitting a panoramic video of claim 6, wherein the requesting the server for the second panoramic video file comprises:
when a variance of the viewing angle of the user is greater than or equal to a second threshold, determining that a current viewing angle of the user is a second viewing angle; and
according to the correspondence between the viewing angle of the user and the video file, requesting the server for the second panoramic video file corresponding to the second viewing angle.

10. The method for transmitting a panoramic video of claim 6, wherein the requesting the server for the second panoramic video file or the auxiliary FOV video file of the first panoramic video file comprises:
when a variance of the viewing angle of the user is less than a second threshold and greater than or equal to a third threshold, determining that a current viewing angle of the user is a third viewing angle; and
according to the correspondence between the viewing angle of the user and the video file, requesting the server for the auxiliary FOV video file of the first panoramic video file corresponding to the third viewing angle;
and
when the variance of the viewing angle of the user is greater than the second threshold, requesting the server for the second panoramic video file.

11. The method for transmitting a panoramic video of claim 1, further comprising:
when requesting the server for the second panoramic video file or the auxiliary FOV video file of the first panoramic video file, carrying in the request a playback starting time point of the second panoramic video file or the auxiliary FOV video file of the first panoramic video file.

12. A method for transmitting a panoramic video, comprising:
sending a media presentation description of a panoramic video file to a terminal; and
sending a FOV video file or send in the panoramic video file;
wherein the media presentation description comprises a field of view (FOV) type of the panoramic video file;
the FOV type of the panoramic video file comprises at least one of the following:
the panoramic video file has a predetermined auxiliary FOV;
the panoramic video file has a predetermined primary FOV; or
the panoramic video file has the predetermined primary FOV and the auxiliary FOV;
wherein sending the FOV video file or sending the panoramic video file comprises:
sending in a single stream, in a case where the panoramic video file has the predetermined primary FOV; and
sending in multiple streams, in a case where the panoramic video file has the predetermined auxiliary FOV;
wherein the single stream is a single virtual reality media stream corresponding to a user's current viewpoint in the primary FOV; and
the multiple streams comprise a panoramic video without the primary FOV, and a plurality of virtual reality media streams of virtual reality block videos with the auxiliary FOV corresponding to a user's current viewpoint or the multiple streams comprise a plurality of virtual reality media streams corresponding to a user's current viewpoint in virtual reality block videos.

13. The method for transmitting a panoramic video of claim 12, wherein the media presentation description further comprises a correspondence between the panoramic video file and the auxiliary FOV video file.

14. A terminal, comprising a processor and a memory storing instructions executable by the processor, wherein when the instructions are executed by the processor, the processor is configured to:
request a server for a first panoramic video file; and
upon detecting a change in a viewing angle of a user, according to a field of view (FOV) type of the first panoramic video file, request the server for a second panoramic video file or an auxiliary FOV video file of the first panoramic video file;
determining a FOV type of the first panoramic video file, wherein the FOV type of the first panoramic video file comprises at least one of the following:
the first panoramic video file has no predetermined FOV
the first panoramic video file has a predetermined auxiliary FOV;
the first panoramic video file has a predetermined primary FOV; or
the first panoramic video file has the predetermined primary FOV and the auxiliary FOV;
wherein, if the first panoramic video file has an auxiliary FOV, or a primary FOV, or a primary FOV and an auxiliary FOV, requesting the server, according to the FOV type of the first panoramic video file and the change of the viewing angle of the user, a second panoramic video file or an auxiliary FOV video file of the first panoramic video file;
wherein requesting, according the FOV type of the first panoramic video file and the change of the viewing angle of the user, the server for acquiring the second panoramic video file) or the auxiliary FOV video file of the first panoramic video file comprises:
requesting in a single stream, in a case where the first panoramic video file has the predetermined primary FOV; and
requesting in multiple streams, in a case where the first panoramic video file has the predetermined auxiliary FOV;
wherein the single stream is a single virtual reality media stream corresponding to a user's current viewpoint in the primary FOV; and
the multiple streams comprise a panoramic video without the primary FOV, and a plurality of virtual reality media streams of virtual reality block videos with the auxiliary FOV corresponding to a user's current viewpoint or the multiple streams comprise a plurality of virtual reality media streams corresponding to a user's current viewpoint in virtual reality block videos.

15. The terminal according to claim 14 wherein the processor is further configured to: request the server for a media presentation description, wherein the media presentation description comprises a correspondence between the viewing angle of the user and a video file, wherein the video file comprises a panoramic video file and an auxiliary FOV video file.

16. The terminal according to claim 15, wherein requesting the server for the auxiliary FOV video file of the first panoramic video file comprises:
when a variance of the viewing angle of the user is greater than a first threshold, the processor is configured to determine that a current viewing angle of the user is a first viewing angle; and
according to the correspondence between the viewing angle of the user and the video file, the processor is configured to request the server for the auxiliary FOV video file of the first panoramic video file corresponding to the first viewing angle.

17. The terminal according to claim 15, wherein requesting the server for the second panoramic video file comprises:
when a variance of the viewing angle of the user is greater than or equal to a second threshold, the processor is configured to determine that a current viewing angle of the user is a second viewing angle; and
according to the correspondence between the viewing angle of the user and the video file, the processor is configured to request the server for the second panoramic video file corresponding to the second viewing angle.

18. The terminal according to claim 15, wherein requesting the server for the second panoramic video file or the auxiliary FOV video file of the first panoramic video file comprises:
when a variance of the viewing angle of the user is less than a second threshold and greater than or equal to a third threshold, the processor is configured to determine that a current viewing angle of the user is a third viewing angle and request, according to the correspondence between the viewing angle of the user and the video file, the server for the auxiliary FOV video file of the first panoramic video file corresponding to the third viewing angle;
when the variance of the viewing angle of the user is greater than the second threshold, the processor is configured to request the server for the second panoramic video file.

19. A server, comprising a processor and a memory storing instructions executable by the processor, wherein when the instructions are executed by the processor, the processor is configured to perform the method for transmitting a panoramic video according to claim 12.
